(19) United States
(12) Patent Application Publication
(10) Pub. No.: US 2019/0084194 A1
(43) Pub. Date: Mar. 21, 2019

(54) STRUCTURE FORMATION USING ELECTROMAGNETIC FIELDS

(71) Applicant: John P. Keady, Fairfax Station, VA (US)

(72) Inventor: John P Keady, Fairfax Station, VA (US)

(21) Appl. No.: 15/922,867

(22) Filed: Mar. 15, 2018

Related U.S. Application Data
(60) Provisional application No. 62/471,861, filed on Mar. 15, 2017.

(51) Int. Cl. B29C 35/08

(52) U.S. Cl. CPC B29C 35/0805; B29C 2035/0827; B29K 2995/0008

(57) ABSTRACT

At least one exemplary embodiment is directed to a method of forming structures using a curable fluid or paste using electromagnetic fields.

### CROSS-REFERENCE TO RELATED APPLICATIONS

This application is a non provisional of and claims priority to U.S. Pat. App. No. 62/471,861 filed 15 Mar. 2017 the disclosure of which is incorporated in its entirety.

### FIELD OF THE INVENTION

The present invention relates to structures formed using magnetic and/or electric fields.

### BACKGROUND OF THE INVENTION

Structures are typically formed by methods such as heat and cure molding, 3D printing, removal of material, riveting, welding, curable epoxies and similar traditional structure forming methods. Many limits exist for these methods, for example complicated shape formations with large undercuts can be difficult to mold, often requiring a draft. A method to form shapes difficult to form by other methods would be useful.

### BRIEF DESCRIPTION OF THE DRAWINGS

Exemplary embodiments of present invention will become more fully understood from the detailed description and the accompanying drawings, wherein:

FIG. 1 illustrates a non-limiting example of a structure formation using a magnetic field;

FIG. 2 is an image of several structures formed by the methods described herein;

FIG. 3 is an image of several structures formed by the methods described herein;

FIG. 4 is an image of several structures formed by the methods described herein; and

FIG. 5 is an image of several structures formed by the methods described herein.

### DETAILED DESCRIPTION OF EXEMPLARY EMBODIMENTS

The following description of exemplary embodiment(s) is merely illustrative in nature and is in no way intended to limit the invention, its application, or uses. For example, the enabling description details use of a method to form structures on an art canvas, however the processes described herein can be used for manufacturing of large and small structures, for example applying magnetic fields to form the first structure, curing , then applying a new field to form a second structure attached to the first structure and so on forming a more complicated structure.

Processes, techniques, apparatus, and materials as known by one of ordinary skill in the art may not be discussed in detail but are intended to be part of the enabling description where appropriate. For example specific materials may not be listed for achieving each of the targeted properties discussed, however one of ordinary skill would be able, without undo experimentation, to determine the materials needed given the enabling disclosure herein. For example Goodson WCD-100-G White Magnetic Powder is mixed with acrylic paint and used to form structures on an art canvas, where curing is done at room temperature, and when cured (paint dried) the magnetic field is removed. However any type of material can be added to curable resins to manipulate the shape of the resins, then the resin cured. For example when forming solid state components photoresist material can be mixed with magnetic and/or electric responsive particles or fluids forming a mixed photoresist so that the mixed photoresist can be manipulated by magnetic and/or electric fields, forming a photoresist shape dependent upon applied fields, then cured rigid, which can then be etched to form solid state structures. Thus such a use of the methods described herein can be used to form maskless solid state structures by varying magnetic and/or electric fields for different designs. A brief description of ferrofluids, magnetorheological fluids, and electrorheological follows.

Ferrofluids are composed of nanoscale particles (diameter usually 10 nanometers or less) of magnetite, hematite or some other compound containing iron. This is small enough for thermal agitation to disperse them evenly within a carrier fluid, and for them to contribute to the overall magnetic response of the fluid. This is analogous to the way that the ions in an aqueous paramagnetic salt solution (such as an aqueous solution of copper(II) sulfate or manganese(II) chloride) make the solution paramagnetic.

Particles in ferrofluids are dispersed in a liquid, often using a surfactant, and thus ferrofluids are colloidal suspensions—materials with properties of more than one state of matter. In this case, the two states of matter are the solid metal and liquid it is in. This ability to change phases with the application of a magnetic field allows them to be used as seals, lubricants, and may open up further applications in future nanoelectromechanical systems.

True ferrofluids are stable. This means that the solid particles do not agglomerate or phase separate even in extremely strong magnetic fields. However, the surfactant tends to break down over time (a few years), and eventually the nano-particles will agglomerate, and they will separate out and no longer contribute to the fluid's magnetic response.

The term magnetorheological fluid (MRF) refers to liquids similar to ferrofluids (FF) that solidify in the presence of a magnetic field. Magnetorheological fluids have micrometer scale magnetic particles that are one to three orders of magnitude larger than those of ferrofluids.

However, ferrofluids lose their magnetic properties at sufficiently high temperatures, known as the Curie temperature. The specific temperature required varies depending on the specific compounds used for the nano-particles.

Electrorheological (ER) fluids are suspensions of extremely fine non-conducting particles (up to 50 micrometres diameter) in an electrically insulating fluid. The apparent viscosity of these fluids changes reversibly by an order of up to 100,000 in response to an electric field. For example, a typical ER fluid can go from the consistency of a liquid to that of a gel, and back, with response times on the order of milliseconds. The change in apparent viscosity is dependent on the applied electric field, i.e. the potential divided by the distance between the plates. The change is not a simple change in viscosity, hence these fluids are now known as ER fluids, rather than by the older term Electro Viscous fluids. The effect is better described as an electric field dependent shear yield stress. When activated an ER fluid behaves as a Bingham plastic (a type of viscoelastic material), with a yield point which is determined by the electric field strength. After the yield point is reached, the fluid shears as a fluid, i.e. the incremental shear stress is proportional to the rate of shear (in a Newtonian fluid there is no yield point and stress is directly proportional to shear). Hence the resistance to motion of the fluid can be controlled by adjusting the applied electric field.

Notice that similar reference numerals and letters refer to similar items in the following figures, and thus once an item is defined in one figure, it may not be discussed or further defined in the following figures. Processes, techniques, apparatus, and materials as known by one of ordinary skill in the relevant art may not be discussed in detail but are intended to be part of the enabling description where appropriate. For example curable liquid can mean any flowable medium, regardless of viscosity, density and temperature, (e.g., molten metal), and cured by various methods, such as two part epoxies, UV light, heat, adding catalyst, air drying, and any other method in which the liquid solidifies over time.

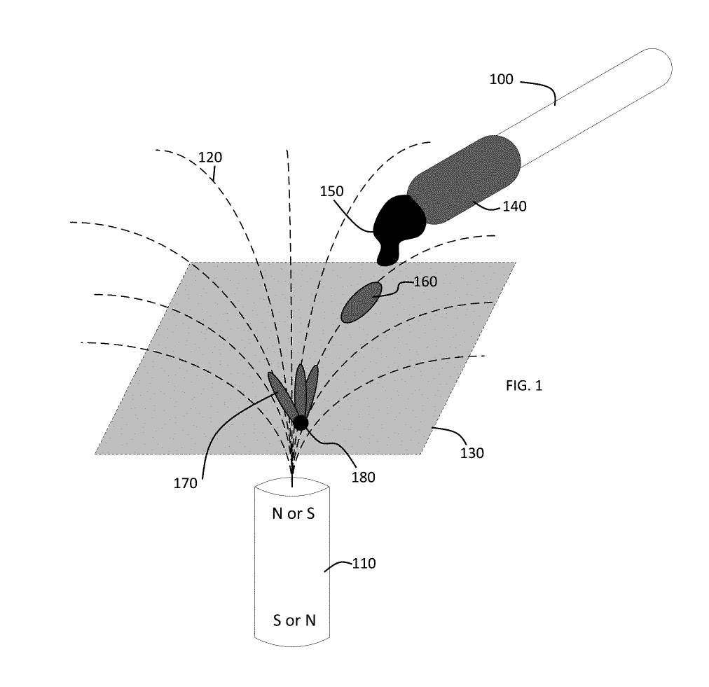

FIG. 1 illustrates a non-limiting example of a structure formation using a magnetic field. An applicator 100 (e.g., paint brush) with curable field responsive curable fluid 140 (e.g., acrylic paint with a portion of weight or volume of magnetic and/or electric responsive substance mixed, for example 1-100% by weight of Goodson WCD-100-G White Magnetic Powder) having a tip 150 can be inserted into a field 120 (e.g., magnetic and/or electric) . The field responsive curable fluid contacting a base 180 will take shapes 170 in response to the fields 120. Note that the base can be a previously fabricated shape using the same process or other processes, for example applying a magnetic field on an object already formed and then applying the field responsive curable fluid onto the object or forming a shape using a first field responsive curable fluid, curing, then applying a second field responsive curable fluid and curing and so on. Forming multiple layers. The field 120 can be caused by a permanent magnet 110, an electric coil to produce a variable magnetic field, a combination of both, or electrodes producing electric fields. For example a conductive plate can be elevated above base 130 and below base 130 to produce an electric field that passes through base 130, where electric field responsive fluid interacts with the electric field.

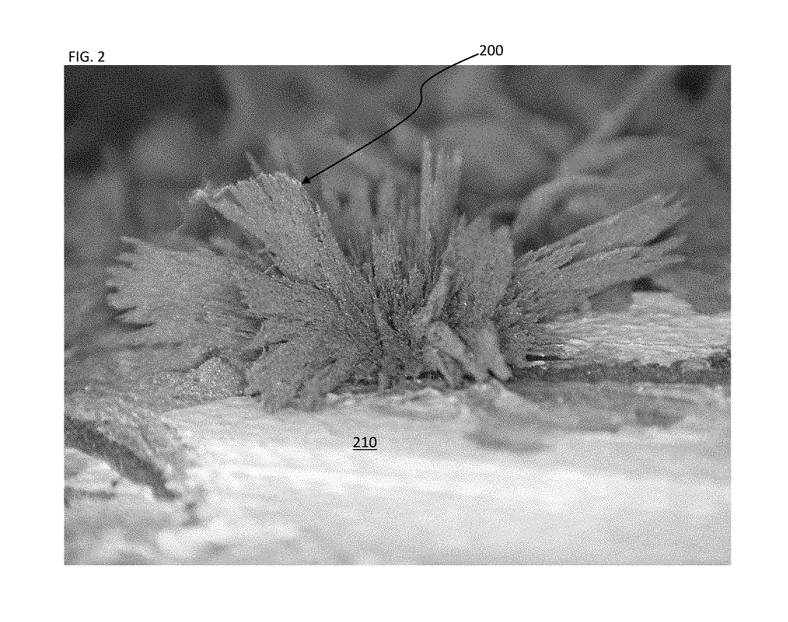

FIG. 2 is an image of several structures 200 formed by the methods described herein on base 210. This non-limiting embodiment is an example of sharp features 200 tens of mm in length, formed by acrylic paint with embedded magnetic power placed in a magnetic field under the canvas. Upon drying of the paint the magnetic field was removed, with the shape being retained by the curable fluid (paint in this case). Note that the curable fluid could be rubber, plastic, molten metal and such that have been modified to be field responsive. For example, High Strength Rubber, two part rubber, can be mixed with the magnetic responsive fine particles then placed into the a magnetic field until the rubber cures, then the field removed. Additionally, other types of curable material can be used for example Alum ilite Flex 40™ casting rubber.

Additional uses can be to move mold material into deep recesses by applying fields to pull or push fluids into different directions.

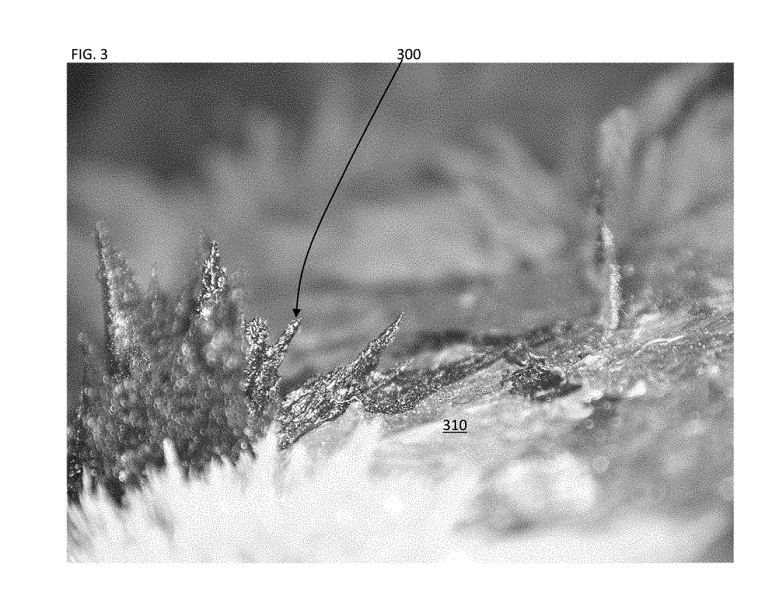

FIG. 3 is an image of several structures 300 formed by the methods described herein on base 310.

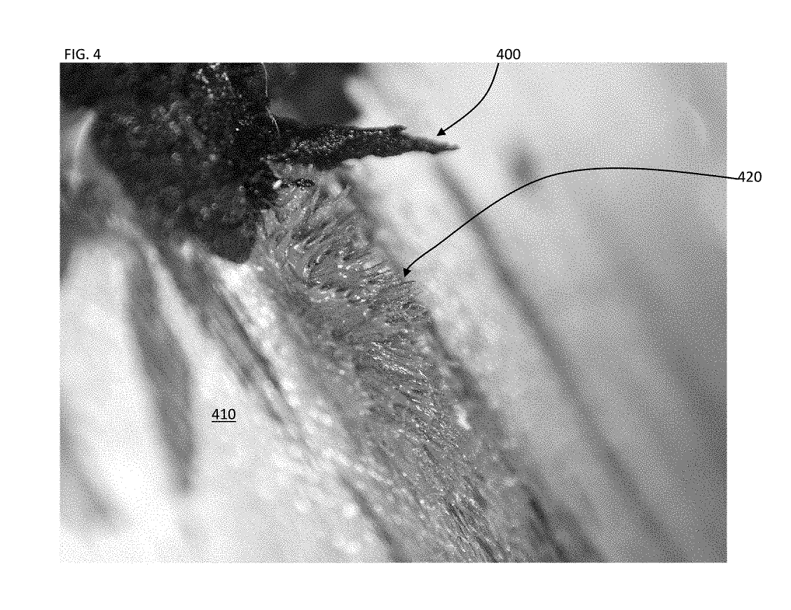

FIG. 4 is an image of several structures 400 and 420 formed by the methods described herein on base 410.

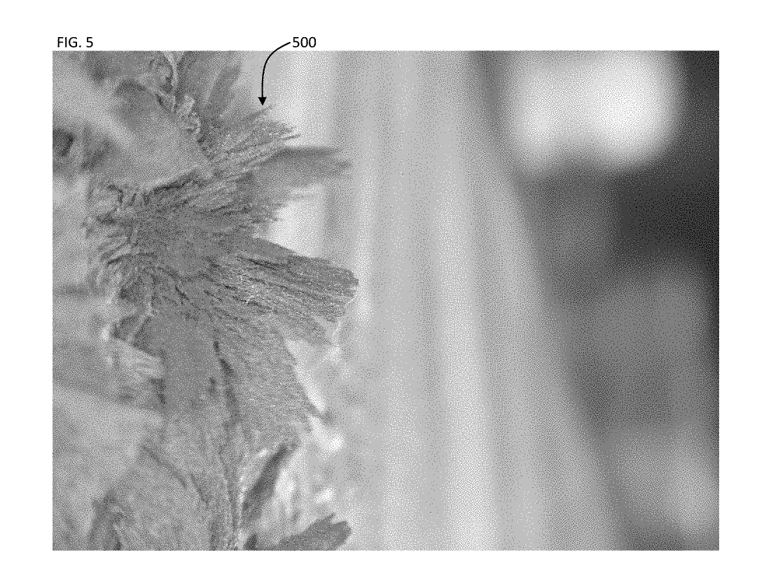

FIG. 5 is an image of several structures 500 formed by the methods described herein. Note that the structures formed can have various shapes and sizes.

Various non-limiting examples of various field responsive mediums been discussed, but in general can include liquids, mixtures, colliodal suspensions, foams, gels, and particle suspensions. For example a colloidal suspension (e.g. aphron where at least one layer is field responsive) can be held in suspension until mixed by a user.

Additional exemplary embodiments use a field responsive fluids (e.g., Electric and Magnetic Fluid Technology: Any device portion that includes ferrofluids, magnetorheological fluids, and Electro-rheological fluids/electric field responsive fluids. For example one exemplary embodiment uses a magnetic generator (e.g., coil) to control FerroFluid in an mold to move from one point of the mold to another. In an ER fluid the viscosity of the fluid can be changed by applying an electric field across the field responsive fluid.

At least one exemplary embodiment also use a combination ER and FF fluid by mixing them so that a magnetic field can be used to move the fluid while an electric field can be used to gellify the fluid.

Processes, techniques, apparatus, and materials as known by one of ordinary skill in the art may not be discussed in detail but are intended to be part of the enabling description where appropriate. For example specific materials may not be listed for achieving each of the targeted properties discussed, however one of ordinary skill would be able, without undo experimentation, to determine the materials needed given the enabling disclosure herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions of the relevant exemplary embodiments. For example, if words such as “orthogonal”, “perpendicular” are used, the intended meaning is “substantially orthogonal” and “substantially perpendicular” respectively. Additionally, although specific numbers may be quoted in the claims, it is intended that a number close to the one stated is also within the intended scope, i.e. any stated number (e.g., 20 mils) should be interpreted to be “about” the value of the stated number (e.g., about 20 mils).

Thus, the description of the invention is merely exemplary in nature and, thus, variations that do not depart from the gist of the invention are intended to be within the scope of the exemplary embodiments of the present invention. Such variations are not to be regarded as a departure from the spirit and scope of the present invention.

What is claimed is:

1. A method of forming a structure comprising:
applying at least one of an electric and magnetic field;
inserting a curable fluid into a region of the at least one of an electric and magnetic field, where the curable fluid is configured to be deformable in response to the at least one of an electric and magnetic field; and
removing the at least one of an electric and magnetic field when the curable fluid forms a self supporting shape, where the self supporting shape retains a substantial portion of its shape when the at least one of an electric and magnetic field is removed forming the structure.

2. The method according to claim 1, where a substantial portion of the shape is defined by there being more than 90% by volume being retained when the at least one of an electric and magnetic field has been removed.

3. A structure comprising:
A cured magnetoresponsive fluid, where a shape of the cured magnetoresponsive fluid was manipulated by the application of at least one of an electric and magnetic field.

4. The structure according to claim 3, where the fluid was cured by application of UV light.
